(19) United States
(12) Patent Application Publication
(10) Pub. No.: US 2024/0291131 A1
(43) Pub. Date: Aug. 29, 2024

(54) DIRECTIONAL COUPLER, RADIO-FREQUENCY CIRCUIT, AND COMMUNICATION DEVICE

(71) Applicant: Murata Manufacturing Co., Ltd., Kyoto (JP)

(72) Inventor: Ikumi TOKUDA, Kyoto (JP)

(21) Appl. No.: 18/657,370

(22) Filed: May 7, 2024

Related U.S. Application Data
(63) Continuation of application No. PCT/JP2022/041523, filed on Nov. 8, 2022.

(30) Foreign Application Priority Data
Nov. 15, 2021 (JP) 2021-185925
Jan. 28, 2022 (JP) 2022-012136

(51) Int. Cl. H01P 5/18

(52) U.S. Cl. CPC H01P 5/18

(57) ABSTRACT

A directional coupler includes an input terminal, an output terminal, a detection terminal, a main line coupled to the input terminal and the output terminal, a sub-line, and a capacitor. The sub-line and the main line are arranged in a manner that enables magnetic field coupling and electric field coupling. The sub-line is coupled to one end of the capacitor and the detection terminal. The other end of the capacitor is coupled to ground.

### CROSS REFERENCE TO RELATED APPLICATION

This is a continuation of International Application No. PCT/JP2022/041523 filed on Nov. 8, 2022 which claims priority from Japanese Patent Application No. 2021-185925 filed on Nov. 15, 2021 and Japanese Patent Application No. 2022-012136 filed on Jan. 28, 2022. The contents of these applications are incorporated herein by reference in their entireties.

### BACKGROUND ART

### Technical Field

The present disclosure relates to directional couplers, radio-frequency circuits, and communication devices.

Some radio-frequency communication devices detect the state of communication signals using, for example, directional couplers, and perform control on communication signals and communication paths based on the state of communication signals. Since load impedance affects the state of communication signals, enhancing the accuracy of load impedance detection is suitable.

In Non Patent Document 1, electric fields are coupled using a capacitive divider to detect electric field coupling signals. Similarly, to detect magnetic field coupling signals, magnetic fields are coupled between a main line and a sub-line, and the voltages at both ends of the sub-line are treated as differential signals.
Non Patent Document 1: “An Impedance Sensor for MEMS Adaptive Antenna Matching”, Armin Tavakol et al., in 2015 IEEE Radio Frequency Integrated Circuits Symposium BRIEF SUMMARY

In Non Patent Document 1, electric field coupling signals and magnetic field coupling signals are detected, instead of detecting electromagnetic field coupling signals. This approach degrades the accuracy of load impedance detection.

The present disclosure provides directional couplers, radio-frequency circuits, and a communication device that can detect electromagnetic field coupling signals, thereby enhancing the accuracy of load impedance detection.

A directional coupler according to an aspect of the present disclosure includes an input terminal, an output terminal, a first detection terminal, a main line coupled to the input terminal and the output terminal, a first sub-line, and a first capacitive element. The first sub-line and the main line are arranged in a manner that enables magnetic field coupling and electric field coupling. The first sub-line is coupled to one end of the first capacitive element and the first detection terminal. The other end of the first capacitive element is coupled to ground.

A directional coupler according to an aspect of the present disclosure includes an input terminal, an output terminal, a first detection terminal, a main line coupled to the input terminal and the output terminal, a first sub-line, and a first capacitive element. The first sub-line and the main line are at least partially positioned adjacent to each other. The first sub-line is coupled to one end of the first capacitive element and the first detection terminal. The other end of the first capacitive element is coupled to ground.

A directional coupler according to an aspect of the present disclosure includes an input terminal, an output terminal, a first detection terminal, a main line coupled to the input terminal and the output terminal, a first sub-line, and a first capacitive element. No interconnection is provided between the first sub-line and the main line. The first sub-line is coupled to one end of the first capacitive element and the first detection terminal. The other end of the first capacitive element is coupled to ground.

A radio-frequency circuit according to an aspect of the present disclosure includes a radio-frequency input terminal and a radio-frequency output terminal, the directional coupler, a first arithmetic circuit coupled to the first detection terminal, a second arithmetic circuit coupled to the second detection terminal, a third arithmetic circuit coupled to the third detection terminal, an adder circuit coupled to the first arithmetic circuit, the second arithmetic circuit, and the third arithmetic circuit, and a radio-frequency circuit component provided in a path connecting the radio-frequency input terminal and the directional coupler or a path connecting the radio-frequency output terminal and the directional coupler and coupled to an output terminal of the adder circuit.

The directional couplers according to some embodiment of the present disclosure can detect electromagnetic field coupling signals, thereby enhancing the accuracy of load impedance detection.

### BRIEF DESCRIPTION OF THE DRAWINGS

FIG. 1 is a circuit configuration diagram of a directional coupler, a radio-frequency circuit, and a communication device according to an embodiment.

FIG. 2A is a plan view of the directional coupler according to the embodiment.

FIG. 2B is a plan view of a first layer constituting the directional coupler according to the embodiment.

FIG. 2C is a plan view of a second layer constituting the directional coupler according to the embodiment.

FIG. 2D is a plan view of a third layer constituting the directional coupler according to the embodiment.

FIG. 2E is a sectional view of the directional coupler according to the embodiment.

FIG. 3 is a circuit configuration diagram of a radio-frequency circuit according to a first modification.

FIG. 4 is a circuit configuration diagram of a radio-frequency circuit according to a second modification.

FIG. 5 is a circuit configuration diagram of a radio-frequency circuit according to a third modification.

FIG. 6 is a circuit configuration diagram of a radio-frequency circuit according to a fourth modification.

### DETAILED DESCRIPTION

Hereinafter, embodiments and modifications of the present disclosure will be described in detail with reference to the drawings. It should be noted that the embodiments and modifications described below provide comprehensive or specific examples. Details, such as numerical values, shapes, materials, constituent elements, and arrangements and connection modes of the constituent elements provided in the following embodiments and modifications are illustrative and are not intended to limit the present disclosure.

The drawings are schematically illustrated with suitable emphasis, omissions, or proportion adjustments to depict the present disclosure and do not necessarily represent exact details; thus, the shapes, positional relationships, and proportions can differ from actual implementations. Identical reference numerals are assigned to substantially the same configuration elements across the drawings, and redundant descriptions of these configuration elements can be omitted or simplified.

In the drawings described later, the x-axis and the y-axis are perpendicular to each other in a plane parallel to the major surfaces of a substrate. The z-axis is perpendicular to the major surfaces of the substrate. Along the z-axis, the positive direction indicates upward, and the negative direction indicates downward.

The terms used in the present disclosure are defined as follows.

The term “couple” applies when one circuit element is directly coupled to another circuit element via a connection terminal and/or a wiring conductor, and the term also applies when one circuit element is electrically couplable to another circuit element via still another circuit element. The term “coupled between A and B” refers to a situation where one circuit element is positioned between A and B and coupled to both A and B. The term applies when the circuit element is coupled in series in the path connecting A and B and also when the circuit element is coupled in parallel (shunt-coupled) between the path and ground.

The term “directly couple” refers to a situation where one circuit element is directly coupled to another circuit element via a connection terminal and/or an interconnect conductor without necessarily involving still another circuit element.

Terms describing relationships between elements, such as “parallel” and “vertical”, terms indicating an element's shape, such as “rectangular”, and numerical ranges are not meant to convey only precise meanings. These terms and numerical ranges denote meanings that are substantially the same, involving, for example, about several percent differences.

The expression “a component A is provided in series in a path B” means that both of the signal input and signal output ends of the component A are coupled to a wire line, an electrode, or a terminal that constitute the path B.

The term “plan view” refers to the perspective of an object orthogonally projected onto an xy plane, viewed from the positive side of the z-axis.

The expression “A and B overlap in plan view of a substrate” refers to a situation where the area of A and the area of B overlap as projected when the substrate is viewed in plan view.

### Embodiment

### 1 Circuit Configuration of Directional Coupler 1, Radio-Frequency Circuit 2, and Communication Device 5

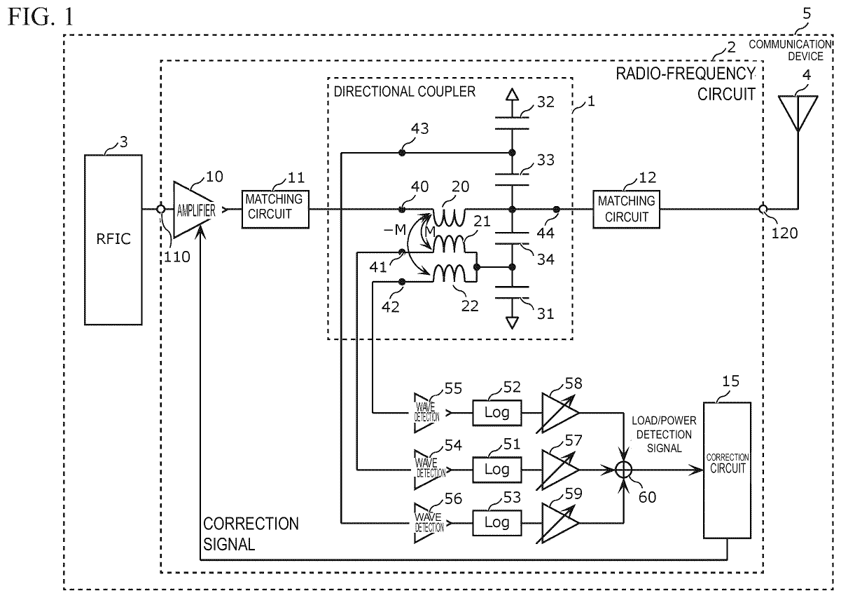

A circuit configuration of a directional coupler 1, a radio-frequency circuit 2, and a communication device 5 according to the present embodiment will be described. FIG. 1 is a circuit configuration diagram of the directional coupler 1, the radio-frequency circuit 2, and the communication device 5 according to the embodiment.

### [1.1 Circuit Configuration of Communication Device 5]

First, a circuit configuration of the communication device 5 will be specifically described with reference to FIG. 1. As illustrated in FIG. 1, the communication device 5 includes the radio-frequency circuit 2, a radio-frequency integrated circuit (RFIC) 3, and an antenna 4.

The radio-frequency circuit 2 is operable to transfer radio-frequency signals between the antenna 4 and the RFIC 3. A detailed circuit configuration of the radio-frequency circuit 2 will be described later.

The antenna 4 is coupled to a radio-frequency output terminal 120 of the radio-frequency circuit 2. The antenna 4 is operable to emit radio-frequency signals output by the radio-frequency circuit 2. The antenna 4 is also operable to receive radio-frequency signals from outside and output the radio-frequency signals to the radio-frequency circuit 2.

The RFIC 3 is an example of a radio frequency signal processing circuit configured to process a radio-frequency signal received or to be transmitted by the antenna 4. Specifically, the RFIC 3 is operable to process, for example by down-conversion, radio-frequency receive signals inputted through receive signal paths of the radio-frequency circuit 2 and output the receive signals generated through the signal processing to a baseband signal processing circuit (BBIC, not illustrated). The RFIC 3 is also operable to process, for example by up-conversion, transmit signals inputted from the BBIC and output the radio-frequency transmit signals generated by the signal processing to transmit signal paths of the radio-frequency circuit 2.

The RFIC 3 is also operable to provide control signals for the radio-frequency circuit 2 to control, for example, the gain of a power amplifier 10 of the radio-frequency circuit 2.

The communication device 5 according to the present embodiment does not necessarily include the antenna 4. In other words, the antenna 4 is an optional constituent element in the communication device according to the present disclosure.

### [1.2 Circuit Configuration of Radio-Frequency Circuit 2]

Next, a circuit configuration of the radio-frequency circuit 2 will be specifically described with reference to FIG. 1. As illustrated in FIG. 1, the radio-frequency circuit 2 includes the directional coupler 1, the power amplifier 10, matching circuits 11 and 12, a correction circuit 15, logarithmic converter circuits 51, 52, and 53, wave detector circuits 54, 55, and 56, gain converter circuits 57, 58, and 59, an adder circuit 60, a radio-frequency input terminal 110, and a radio-frequency output terminal 120.

The directional coupler 1 includes an input terminal 40, an output terminal 44, detection terminals 41, 42 and 43, a main line 20, sub-lines 21 and 22, and capacitors 31, 32, 33 and 34.

The main line 20 is a line with one end coupled to the input terminal 40 and the other end coupled to the output terminal 44, designed to carry radio-frequency signals output by the power amplifier 10.

The sub-line 21 is an example of a first sub-line. The sub-line 21 is arranged in a manner that enables magnetic field coupling and electric field coupling with the main line. The main line 20 and the sub-line 21 are positioned adjacent to each other with a space or dielectric member interposed therebetween. The sub-line 21 has one end coupled to one end of the capacitor 31 and the other end coupled to the detection terminal 41.

The sub-line 22 is an example of a second sub-line. The sub-line 22 is arranged in a manner that enables magnetic field coupling and electric field coupling with the main line. The main line 20 and the sub-line 22 are positioned adjacent to each other with a space or dielectric member interposed therebetween. The sub-line 22 has one end coupled to the one end of the capacitor 31 and the other end coupled to the detection terminal 42.

The capacitor 31 is an example of a first capacitive element. The capacitor 31 has one end coupled to the sub-lines 21 and 22 and the other end coupled to ground.

The capacitor 32 is an example of a second capacitive element. The capacitor 32 is provided in series in a first path connecting the main line 20 and ground.

The capacitor 33 is an example of a third capacitive element. The capacitor 33 is provided in series in the first path between the capacitor 32 and the main line 20.

The capacitor 34 is provided in series in a second path connecting the main line 20 and ground, between the capacitor 31 and the main line 20.

The detection terminal 41 is an example of a first detection terminal. The detection terminal 41 is provided in a path connecting the sub-line 21 and the wave detector circuit 54. The detection terminal 42 is an example of a second detection terminal. The detection terminal 42 is provided in a path connecting the sub-line 22 and the wave detector circuit 55. The detection terminal 43 is an example of a third detection terminal. The detection terminal 43 is provided in a path connecting the wave detector circuit 56 and a connection point of the capacitors 32 and 33 in the first path.

It is sufficient for the directional coupler 1 according to the present embodiment to include the main line 20, the sub-line 21, the capacitor 31, the input terminal 40, the output terminal 44, and the detection terminal 41. The directional coupler 1 does not necessarily include the detection terminals 42 and 43, the sub-line 22, and the capacitors 32, 33, and 34.

In known directional couplers, the sub-line terminates with a resistor in place of the capacitor 31. As a result, the signals generated by the sub-line have only real components. By contrast, in the directional coupler 1 according to the present embodiment, the main line 20 and the sub-line 21 are arranged in a manner that enables magnetic field coupling and electric field coupling, and the capacitor 31 is incorporated. With this configuration, signals can be generated in the sub-line 21 through electromagnetic field coupling. These signals are formed by combining signal components generated through magnetic field coupling and signal components generated through electric field coupling in an out-of-phase manner. These signals generated through electromagnetic field coupling can be output from the detection terminal 41. This configuration enables the directional coupler 1 to detect signals generated through electromagnetic field coupling and use the signals to enhance the accuracy of load impedance detection.

In the configuration described above of the directional coupler 1, the main line 20 and the sub-lines 21 and 22 are arranged in a manner that enables magnetic field coupling and electric field coupling, and the capacitor 31 is incorporated. This configuration enables detection of signals corresponding to the radio-frequency signals traveling through the main line 20, using the detection terminals 41 and 42 of the sub-lines 21 and 22.

The expression “the main line 20 and the sub-lines 21 and 22 are arranged in a manner that enables magnetic field coupling and electric field coupling” specifically refers to an arrangement where at least a portion of the main line 20, and at least a portion of the sub-line 21 and at least a portion of the sub-line 22 are positioned adjacent to each other. The expression “a main line and a sub-line are positioned adjacent to each other” refers to an arrangement where “no interconnections for carrying RF signals are provided between the main line and the sub-line.” As described above, the main line 20 and the sub-lines 21 and 22 are positioned adjacent to each other, with at least partial alignment in the longitudinal direction. This arrangement enables magnetic field coupling and electric field coupling between the main line 20 and the sub-lines 21 and 22.

The term “positioned adjacent” refers to an arrangement where a main line and a sub-line are provided in the same layer, and also an arrangement where a main line and a sub-line are provided in different layers. When a main line and a sub-line are provided in different layers, the term “positioned adjacent” in the present embodiment also refers to an arrangement where the main line and the sub-line overlap in the plan view of a substrate.

The physical configuration of the directional coupler 1 will be described later.

The power amplifier 10 (labeled as “AMPLIFIER” in FIG. 1) is an example of a radio-frequency circuit component. The power amplifier 10 is designed to amplify radio-frequency signals input by the RFIC 3 through the radio-frequency input terminal 110. The power amplifier 10 is an example of an amplifier. The power amplifier 10 is provided in a path connecting the radio-frequency input terminal 110 and the directional coupler 1. The gain of the power amplifier 10 can be varied based on the signals output by the adder circuit 60.

The power amplifier 10 may have a multi-stage configuration with multiple field-effect transistors coupled in multiple stages. The transistors constituting the power amplifier 10 may be bipolar transistors having base, emitter, and collector. The transistors constituting the power amplifier 10 may be, for example, complementary metal oxide semiconductor (CMOS) transistors constructed through a silicon on insulator (SOI) process. The transistors constituting the power amplifier 10 may be GaAs or SiGe transistors.

In place of the power amplifier 10, the radio-frequency circuit 2 may include a low-noise amplifier coupled between the radio-frequency input terminal 110 and the directional coupler 1.

The matching circuit 11 is an example of a radio-frequency circuit component. The matching circuit 11 is an impedance matching circuit coupled between an output terminal of the power amplifier 10 and the input terminal 40, designed to provide impedance matching between the power amplifier 10 and the main line 20. The matching circuit 12 is an example of a radio-frequency circuit component. The matching circuit 12 is an impedance matching circuit coupled between the output terminal 44 and the radio-frequency output terminal 120, designed to provide impedance matching between the main line 20 and the antenna 4. Each of the matching circuits 11 and 12 includes at least one of an inductor and a capacitor.

The wave detector circuit 54 (labeled as WAVE DETECTION in FIG. 1) is an example of a first wave detector circuit. The wave detector circuit 54 is coupled between the detection terminal 41 and the logarithmic converter circuit 51. The wave detector circuit 54 is designed to detect a first alternating current signal in the sub-line 21 and convert the first alternating current signal into a first direct current signal. The wave detector circuit 55 (labeled as WAVE DETECTION in FIG. 1) is an example of a second wave detector circuit. The wave detector circuit 55 is coupled between the detection terminal 42 and the logarithmic converter circuit 52. The wave detector circuit 55 is designed to detect a second alternating current signal in the sub-line 22 and convert the second alternating current signal into a second direct current signal. The wave detector circuit 56 (labeled as WAVE DETECTION in FIG. 1) is an example of a third wave detector circuit. The wave detector circuit 56 is coupled between the detection terminal 43 and the logarithmic converter circuit 53. The wave detector circuit 56 is designed to detect a third alternating current signal at a connection point of the capacitors 32 and 33 and convert the third alternating current signal into a third direct current signal. As such, the wave detector circuits 54 to 56 detect the amplitudes of the first alternating current signal to the third alternating current signal. Since the wave detector circuits 54 to 56 convert alternating current signals into direct current signals, in the circuit in the subsequent stage after the wave detector circuits 54 to 56, the power component, the load impedance resistance component, and the load impedance reactance component can be extracted simply through calculation of direct current signals.

The logarithmic converter circuit 51 (labeled as Log in FIG. 1) is an example of a first arithmetic circuit. The logarithmic converter circuit 51 is coupled to the detection terminal 41 via the wave detector circuit 54. The logarithmic converter circuit 51 is designed to logarithmically convert the first direct current signal output by the wave detector circuit 54 into a first logarithmic signal and output the first logarithmic signal. The logarithmic converter circuit 52 (labeled as Log in FIG. 1) is an example of a second arithmetic circuit. The logarithmic converter circuit 52 is coupled to the detection terminal 42 via the wave detector circuit 55. The logarithmic converter circuit 52 is designed to logarithmically convert the second direct current signal output by the wave detector circuit 55 into a second logarithmic signal and outputs the second logarithmic signal. The logarithmic converter circuit 53 (labeled as Log in FIG. 1) is an example of a third arithmetic circuit. The logarithmic converter circuit 53 is coupled to the detection terminal 43 via the wave detector circuit 56. The logarithmic converter circuit 53 is designed to logarithmically convert the third direct current signal output by the wave detector circuit 56 into a third logarithmic signal and outputs the third logarithmic signal.

The first direct current signal to the third direct current signal, which are the amplitude components of the first alternating current signal to the third alternating current signal obtained from the directional coupler 1, correspond to the component obtained by multiplying the input power (power component) of the radio-frequency signals input to the main line 20 from the input terminal 40 by the reflection coefficient (the real component (load impedance resistance component) and the imaginary component (load impedance reactance component)) of a load coupled to the output terminal 44. To separate and extract the power component, the load impedance resistance component, and the load impedance reactance component with high accuracy in the gain converter circuits 57 to 59 and the adder circuit 60 in the subsequent stages using the first direct current signal to the third direct current signal, the logarithmic converter circuits 51 to 53 converts the first direct current signal to the third direct current signal, which correspond to the component obtained by multiplication of power and the reflection coefficient, into components obtained by addition and subtraction of power and the reflection coefficient.

The logarithmic converter circuits 51 to 53 may include diodes or bipolar transistors for logarithmic conversion of the first direct current signal to the third direct current signal. Since the voltage-current characteristic of diodes and bipolar transistors exhibits an exponential function, an input-output characteristic that follows a logarithmic function can be achieved by using current as the input and voltage as the output.

The gain converter circuit 57 is an example of a first gain converter circuit. The gain converter circuit 57 is coupled between the logarithmic converter circuit 51 and the adder circuit 60. The gain converter circuit 57 is designed to convert the first logarithmic signal output by the logarithmic converter circuit 51 into a first gain signal using a first gain and output the first gain signal. The gain converter circuit 58 is an example of a second gain converter circuit. The gain converter circuit 58 is coupled between the logarithmic converter circuit 52 and the adder circuit 60. The gain converter circuit 58 is designed to convert the second logarithmic signal output by the logarithmic converter circuit 52 into a second gain signal using a second gain and output the second gain signal. The gain converter circuit 59 is an example of a third gain converter circuit. The gain converter circuit 59 is coupled between the logarithmic converter circuit 53 and the adder circuit 60. The gain converter circuit 59 is designed to convert the third logarithmic signal output by the logarithmic converter circuit 53 into a third gain signal using a third gain and output the third gain signal.

The gain converter circuits 57 to 59 control the weights of the first gain signal, the second gain signal, and the third gain signal for the addition in the adder circuit 60.

In this manner, three kinds of gain signals converted using three different gains are obtained for the three parameters to be extracted: power component, load impedance resistance component, and load impedance reactance component. Consequently, the power component, the load impedance resistance component, and the load impedance reactance component can be extracted.

The adder circuit 60 is coupled to the logarithmic converter circuits 51, 52, and 53 via the gain converter circuits 57, 58, and 59. The adder circuit 60 is designed to add the first gain signal, the second gain signal, and the third gain signal output from the gain converter circuits 57, 58, and 59. The adder circuit 60 has a function of subtracting at least one of the first gain signal to the third gain signal output from the gain converter circuits 57, 58, and 59. The addition signal resulting from the addition in the adder circuit 60 can be output to the correction circuit 15.

The proportions of the first gain, the second gain, and the third gain can be adjusted with the gain converter circuits 57 to 59. With this adjustment, the signal corresponding to the power component in the main line 20, the signal corresponding to the load impedance resistance component in the main line 20, and the signal corresponding to the load impedance reactance component in the main line 20 can be output from the adder circuit 60 with high accuracy. In other words, the combination of the gains of the gain converter circuits 57 to 59 can determine which of the power component, the load impedance resistance component, and the load impedance reactance component is to be extracted. The gains of the gain converter circuits 57 to 59 are not necessarily variable and may correspond to fixed values.

Using the wave detector circuits 54 to 56, the logarithmic converter circuits 51 to 53, the gain converter circuits 57 to 59, and the adder circuit 60, the first alternating current signal to the third alternating current signal output by the directional coupler 1 can be converted to direct current signals, logarithmically converted, and gain converted. As such, the power component, the load impedance resistance component, and the load impedance reactance component can be extracted with high accuracy through simple arithmetic processing.

The correction circuit 15 is an example of a control circuit. The correction circuit 15 is coupled between an output terminal of the adder circuit 60 and the power amplifier 10. The correction circuit 15 is designed to generate a correction signal corresponding to the addition signal output by the adder circuit 60 and outputs the correction signal to the power amplifier 10. This correction signal optimizes, for example, a supply voltage (Vcc) or bias voltage (or current) supplied to the power amplifier 10. The output destination of the correction signal may be the matching circuit 11 or 12 as well as the power amplifier 10.

It is sufficient for the radio-frequency circuit 2 according to the present embodiment to include the directional coupler 1, the power amplifier 10, the logarithmic converter circuits 51 to 53, and the adder circuit 60. The radio-frequency circuit 2 does not necessarily include the matching circuits 11 and 12, the correction circuit 15, the wave detector circuits 54 to 56, and the gain converter circuits 57 to 59. When the radio-frequency circuit 2 does not include the correction circuit 15, the output terminal of the adder circuit 60 may be coupled to the power amplifier 10 to directly supply the output signal from the adder circuit 60 to the power amplifier 10. The correction circuit 15 may be included in the RFIC 3.

In some known radio-frequency circuits, because the power detector detects signals in the sub-line using electric field coupling and magnetic field coupling, it is difficult to easily extract phase information (real component+imaginary component). To extract phase information (real component+imaginary component), complex circuits such as phase comparators need to be used. Additionally, when phase information is extracted, the signal can deteriorate while passing through the complex circuits, resulting in reduced accuracy. As a result, the load reflection coefficient cannot be accurately obtained, in other words, the load impedance cannot be accurately determined. As such, configuring highly accurate load variation compensation circuits has been difficult.

By contrast, with the configuration described above of the radio-frequency circuit 2, three kinds of signals including at least two electromagnetic field coupling signals containing imaginary components can be output from the detection terminals and logarithmically converted and added together. Consequently, the power of radio-frequency signals and the magnitude and phase of the load reflection coefficient can be accurately detected. This configuration enhances the accuracy of load impedance detection.

Using the extracted power of radio-frequency signals and the extracted magnitude and phase of the load reflection coefficient, the correction circuit 15 stabilizes the power of the radio-frequency signals traveling through the main line 20.

### [1.3 Physical Configuration of Directional Coupler 1]

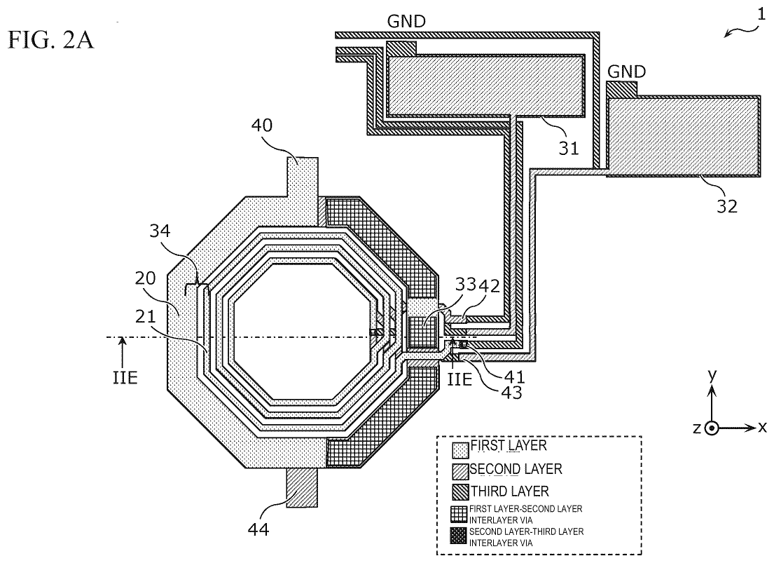

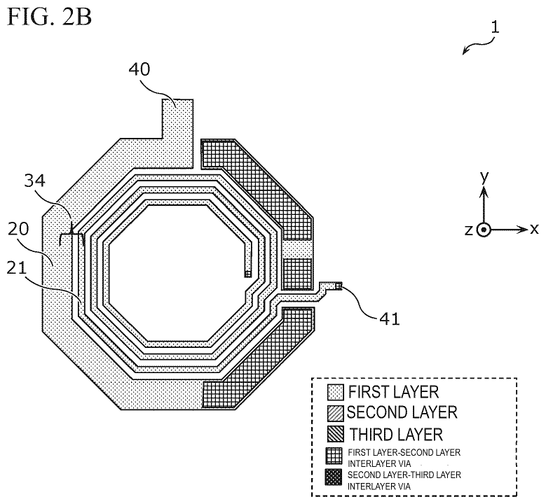

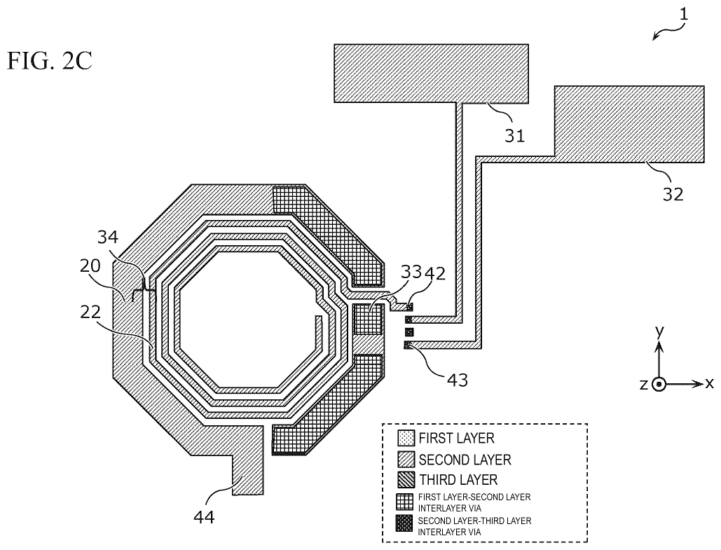

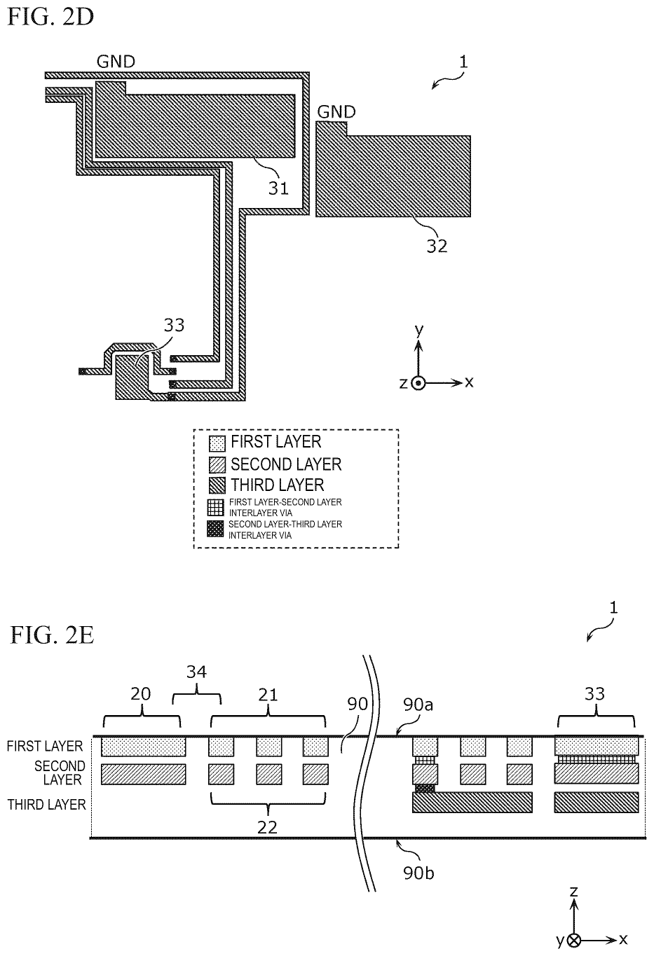

Next, a physical configuration of the directional coupler 1 will be specifically described with reference to FIGS. 2A to 2E.

FIG. 2A is a plan view of the directional coupler 1 according to the embodiment. FIG. 2B is a plan view of a first layer constituting the directional coupler 1 according to the embodiment. FIG. 2C is a plan view of a second layer constituting the directional coupler 1 according to the embodiment. FIG. 2D is a plan view of a third layer constituting the directional coupler 1 according to the embodiment. FIG. 2E is a sectional view of the directional coupler 1 according to the embodiment. More specifically, FIG. 2A illustrates the directional coupler 1 as a major surface 90a of a substrate 90 is viewed in a transparent view from the positive side of the z-axis. FIG. 2B illustrates the first layer (the major surface 90a) as viewed from the positive side of the z-axis. FIG. 2C illustrates the second layer as viewed from the positive side of the z-axis. FIG. 2D illustrates the third layer as viewed from the positive side of the z-axis. FIG. 2E illustrates a section taken along line IIE-IIE in FIG. 2A.

As illustrated in FIGS. 2A to 2E, the directional coupler 1 includes the substrate 90 in addition to the circuit elements illustrated in FIG. 1.

The substrate 90 has major surfaces 90a and 90b that are opposite to each other. The substrate 90 has a structure consisting of the first layer, the second layer, and the third layer that are layered in this order starting from the major surface 90a. For example, a silicon substrate, printed circuit board (PCB), low temperature co-fired ceramics (LTCC) substrate, or resin multilayer substrate may be used as the substrate 90. However, this is not to be interpreted as limiting. When the substrate 90 is formed by, for example, a silicon substrate, at least the main line 20 and the sub-lines 21 and 22 are formed in an integrated circuit (IC) that includes the substrate 90.

As illustrated in FIGS. 2A and 2B, a portion of the main line 20 and the sub-line 21 are formed in the first layer of the substrate 90. The portion of the main line 20 is formed by a substantially annular planar conductor in the first layer. The sub-line 21 is formed by a spiral-shaped planar conductor in the first layer. The main line 20 and the sub-line 21 are positioned adjacent to each other with at least partial alignment in the longitudinal direction. With the arrangement of the main line 20 and the sub-line 21, the capacitor 34 is formed between the main line 20 and the sub-line 21. When viewed from the major surface 90a side (the positive side of the z-axis), the main line 20 is formed counterclockwise in the first layer and the second layer from the input terminal 40, and the sub-line 21 is formed clockwise in the first layer from the detection terminal 41. With this configuration, the main line 20 and the sub-line 21 are couplable through electric fields and magnetic fields, exhibiting, for example, a mutual inductance M. One of the electrodes constituting the capacitor 33 is formed in the first layer.

As illustrated in FIGS. 2A and 2C, a portion of the main line 20 and the sub-line 22 are formed in the second layer of the substrate 90. The portion of the main line 20 is formed by a substantially annular planar conductor in the second layer. The sub-line 22 is formed by a spiral-shaped planar conductor in the second layer. The main line 20 and the sub-line 22 are positioned adjacent to each other with at least partial alignment in the longitudinal direction. With the arrangement of the main line 20 and the sub-line 22, the capacitor 34 is formed between the main line 20 and the sub-line 22. When viewed from the major surface 90a side (the positive side of the z-axis), the main line 20 is formed counterclockwise in the first layer and the second layer from the input terminal 40, and the sub-line 22 is formed counterclockwise in the second layer from the detection terminal 42. With this configuration, the main line 20 and the sub-line 22 are couplable through electric fields and magnetic fields, exhibiting, for example, a mutual inductance (−M). One of the electrodes constituting the capacitor 31, one of the electrodes constituting the capacitor 32, and one of the electrodes constituting the capacitor 33 are formed in the second layer.

Alternatively to substantially annular or spiral-shaped planar conductors, the main line 20 and the sub-lines 21 and 22 may by formed by meander-shaped planar conductors. When a relatively small inductance is sufficient for at least a portion of the main line 20 and the sub-lines 21 and 22 is relatively small, this portion may be formed by a simple linear wire.

As illustrated in FIG. 2D, the other of the electrodes constituting the capacitor 31, the other of the electrodes constituting the capacitor 32, and the other of the electrodes constituting the capacitor 33 are formed in the third layer.

In the physical configuration described above of the directional coupler 1, the main line 20 and the sub-lines 21 and 22 are arranged in a manner that enables magnetic field coupling and electric field coupling, and the capacitor 31 is incorporated. This configuration enables detection of signals corresponding to the radio-frequency signals traveling through the main line 20, using the detection terminals 41 and 42 of the sub-lines 21 and 22.

The capacitors 31 to 34 may be implemented by inter-wire capacitances formed by two wires and a dielectric interposed between the two wires, as exemplified by the capacitor 34 of the present embodiment. The capacitors 31 to 34 may be capacitors formed by two facing planar electrodes and a dielectric interposed between the two planar electrodes, as exemplified by the capacitors 31 to 33 of the present embodiment. The capacitors 31 to 34 may be capacitors formed by comb-shaped electrodes. The capacitors 31 to 34 may be capacitors formed using meta l oxide semiconductor (MOS).

### [1.4 Circuit Configuration of Radio-Frequency Circuit 2A According to First Modification]

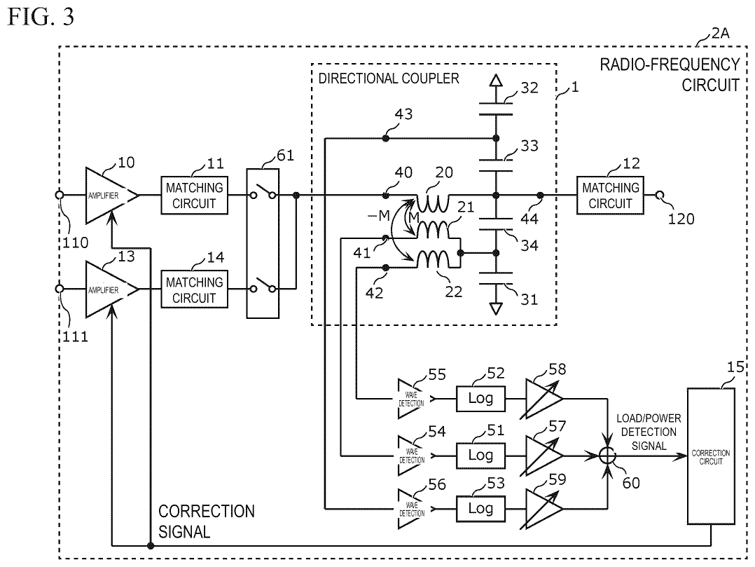

Next, a circuit configuration of a radio-frequency circuit 2A according to a first modification will be specifically described with reference to FIG. 3. As illustrated in FIG. 3, the radio-frequency circuit 2A includes a directional coupler 1, power amplifiers 10 and 13, matching circuits 11, 12, and 14, a correction circuit 15, logarithmic converter circuits 51, 52, and 53, wave detector circuits 54, 55, and 56, gain converter circuits 57, 58, and 59, an adder circuit 60, a switch 61, radio-frequency input terminals 110 and 111, and a radio-frequency output terminal 120. The radio-frequency circuit 2A according to the present modification differs from the radio-frequency circuit 2 according to the embodiment primarily in that the power amplifier 13, the matching circuit 14, and the switch 61 are additionally incorporated. The following describes the radio-frequency circuit 2A according to the present modification with a main focus on configurational features different from the radio-frequency circuit 2 according to the embodiment, and descriptions of the same configurational features as the radio-frequency circuit 2 will not be repeated.

The power amplifier 13 is an example of a radio-frequency circuit component. The power amplifier 13 is designed to amplify radio-frequency signals input by the RFIC 3 through the radio-frequency input terminal 111. The power amplifier 13 is an example of an amplifier. The power amplifier 13 is provided in a path connecting the radio-frequency input terminal 111 and the directional coupler 1. The gain of the power amplifier 13 can be varied based on the signals output by the adder circuit 60.

The matching circuit 14 is an example of a radio-frequency circuit component. The matching circuit 14 is coupled between an output terminal of the power amplifier 13 and an input terminal 40. The matching circuit 14 is designed to provide impedance matching between the power amplifier 13 and a main line 20.

The switch 61 is coupled between the power amplifiers 10 and 13 and the input terminal 40. The switch 61 is designed to switch between the connection of the power amplifier 10 and the input terminal 40 and the connection of the power amplifier 13 and the input terminal 40.

The correction circuit 15 is coupled between an output terminal of the adder circuit 60 and the power amplifiers 10 and 13. The correction circuit 15 is designed to generate a correction signal corresponding to the addition signal output by the adder circuit 60 and outputs the correction signal to the power amplifiers 10 and 13. This correction signal optimizes, for example, a supply voltage (Vcc) or bias voltage (or current) supplied to the power amplifiers 10 and 13. The output destination of the correction signal may be the matching circuit 11, 12, or 14 in place of the power amplifiers 10 and 13.

By contrast, with the configuration described above of the radio-frequency circuit 2A, three kinds of signals including at least two electromagnetic field coupling signals containing imaginary components can be output from the detection terminals and logarithmically converted and added together. Consequently, the power of radio-frequency signals output by the power amplifiers 10 and 13 and the magnitude and phase of the load reflection coefficient can be accurately detected. As such, for example, this configuration can enhance the accuracy of load impedance detection for individual radio-frequency signals of different frequencies.

### [1.5 Circuit Configuration of Radio-Frequency Circuit 2B According to Second Modification]

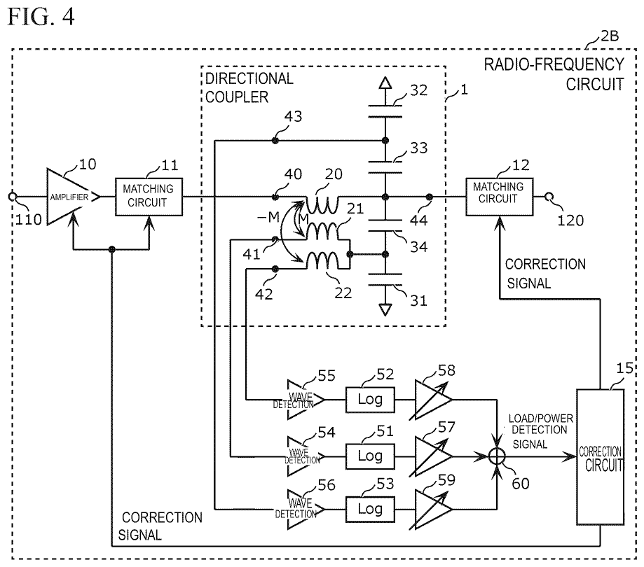

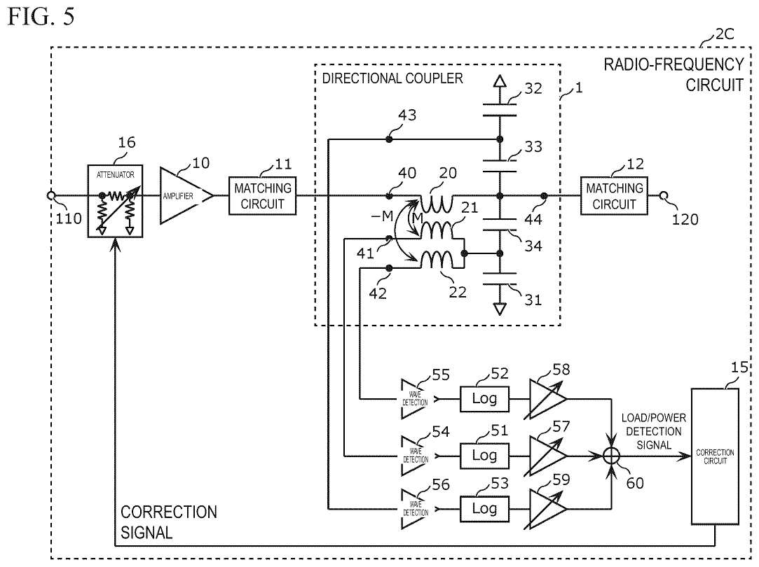

Next, a circuit configuration of a radio-frequency circuit 2B according to a second modification will be specifically described with reference to FIG. 4. As illustrated in FIG. 4, the radio-frequency circuit 2B includes a directional coupler 1, a power amplifier 10, matching circuits 11 and 12, a correction circuit 15, logarithmic converter circuits 51, 52, and 53, wave detector circuits 54, 55, and 56, gain converter circuits 57, 58, and 59, an adder circuit 60, a radio-frequency input terminal 110, and a radio-frequency output terminal 120. The radio-frequency circuit 2B according to the present modification differs from the radio-frequency circuit 2 according to the embodiment in that the output destination of correction signals includes the matching circuits 11 and 12 as well as the power amplifier 10. The following describes the radio-frequency circuit 2B according to the present modification with a main focus on configurational features different from the radio-frequency circuit 2 according to the embodiment, and descriptions of the same configurational features as the radio-frequency circuit 2 will not be repeated.

The correction circuit 15 is designed to output correction signals to the power amplifier 10 and the matching circuits 11 and 12.

The matching circuit 11 is an example of a radio-frequency circuit component. The matching circuit 11 is provided in a path connecting the radio-frequency input terminal 110 and the directional coupler 1. The matching circuit 11 is designed to provide impedance matching between the power amplifier 10 and a main line 20 by adjusting impedance based on the signal output by the adder circuit 60.

The matching circuit 12 is an example of a radio-frequency circuit component. The matching circuit 12 is provided in a path connecting the radio-frequency output terminal 120 and the directional coupler 1. The matching circuit 12 is designed to provide impedance matching between the main line 20 and an antenna 4 by adjusting impedance based on the signal output by the adder circuit 60.

Each of the matching circuits 11 and 12 includes at least one of a variable inductor and a variable capacitor; the inductance of the variable inductor is variable, and the capacitance of the variable capacitor is variable.

The correction circuit 15 is coupled between an output terminal of the adder circuit 60, and the power amplifier 10 and the matching circuits 11 and 12. The correction circuit 15 is designed to generate a correction signal corresponding to the addition signal output by the adder circuit 60 and outputs the correction signal to the power amplifier 10 and the matching circuits 11 and 12. This correction signal optimizes, for example, a supply voltage (Vcc) or bias voltage (or current) supplied to the power amplifier 10 and also the impedances of the matching circuits 11 and 12.

By contrast, with the configuration described above of the radio-frequency circuit 2B, three kinds of signals including at least two electromagnetic field coupling signals containing imaginary components can be output from the detection terminals and logarithmically converted and added together. Consequently, the power of radio-frequency signals output by the power amplifier 10 and the magnitude and phase of the load reflection coefficient can be accurately detected. As a result, the highly accurately detected load impedance can be fed back to various radio-frequency circuit components.

### [1.6 Circuit Configuration of Radio-Frequency Circuit 2C According to Third Modification]

Next, a circuit configuration of a radio-frequency circuit 2C according to a third modification will be specifically described with reference to FIG. 5. As illustrated in FIG. 5, the radio-frequency circuit 2C includes a directional coupler 1, a power amplifier 10, an attenuator 16, matching circuits 11 and 12, a correction circuit 15, logarithmic converter circuits 51, 52, and 53, wave detector circuits 54, 55, and 56, gain converter circuits 57, 58, and 59, an adder circuit 60, a radio-frequency input terminal 110, and a radio-frequency output terminal 120. The radio-frequency circuit 2C according to the present modification differs from the radio-frequency circuit 2 according to the embodiment in that the attenuator 16 is additionally incorporated, and the output destination of correction signals is the attenuator 16. The following describes the radio-frequency circuit 2C according to the present modification with a main focus on configurational features different from the radio-frequency circuit 2 according to the embodiment, and descriptions of the same configurational features as the radio-frequency circuit 2 will not be repeated.

The attenuator 16 is an example of a radio-frequency circuit component. The attenuator 16 is coupled between the radio-frequency input terminal 110 and the power amplifier 10. The attenuation rate of the attenuator 16 can be varied based on the signals output by the adder circuit 60. With this configuration, the attenuator 16 is able to attenuate radio-frequency signals input from the radio-frequency input terminal 110. The attenuator 16, for example, consists of multiple resistive elements. At least one of the resistive elements is a variable resistive element, and the resistance of the resistive element is variable.

The correction circuit 15 is coupled between an output terminal of the adder circuit 60 and the attenuator 16. The correction circuit 15 is designed to generate a correction signal corresponding to the addition signal output by the adder circuit 60 and outputs the correction signal to the attenuator 16. For example, the attenuation rate of the attenuator 16 can be varied base on this correction signal. The output destination of the correction signal may be the power amplifier 10, or the matching circuit 11 or 12 as well as the attenuator 16.

For example, when the gain of the power amplifier 10 is varied in an increasing manner, the attenuation rate of the attenuator 16 is increased via the correction signal obtained through signal processing of the first radio-frequency signal to the third radio-frequency signal detected using the directional coupler 1. This configuration suppresses the increase in the power of radio-frequency signals output by the power amplifier 10.

By contrast, with the configuration described above of the radio-frequency circuit 2C, three kinds of signals including at least two electromagnetic field coupling signals containing imaginary components can be output from the detection terminals and logarithmically converted and added together. Consequently, the power of radio-frequency signals output by the power amplifier 10 and the magnitude and phase of the load reflection coefficient can be accurately detected. As a result, the highly accurately detected power information and load impedance information (correction signal) can be fed back to the attenuator 16 to mitigate power variations caused by gain variations of the power amplifier 10.

In the radio-frequency circuit 2C, it is desirable to incorporate the attenuator 16 between the radio-frequency input terminal 110 and the power amplifier 10 (in the stage before the power amplifier 10) rather than between the power amplifier 10 and the directional coupler 1 (in the stage after the power amplifier 10). If the attenuator 16 is provided in the stage after the power amplifier 10, the amplified high power signals are to be attenuated, which can lead to reduced efficiency.

In place of the power amplifier 10, the radio-frequency circuit 2C may include a low-noise amplifier coupled between the radio-frequency input terminal 110 and the directional coupler 1. In this case, it is desirable to incorporate the attenuator 16 on the output terminal side of the low-noise amplifier (in the stage after the low-noise amplifier). If the attenuator 16 is provided in the stage before the low-noise amplifier, the attenuator 16 can attenuate weak input signals, resulting in reduced receive sensitivity.

### [1.7 Circuit Configuration of Radio-Frequency Circuit 2D According to Fourth Modification]

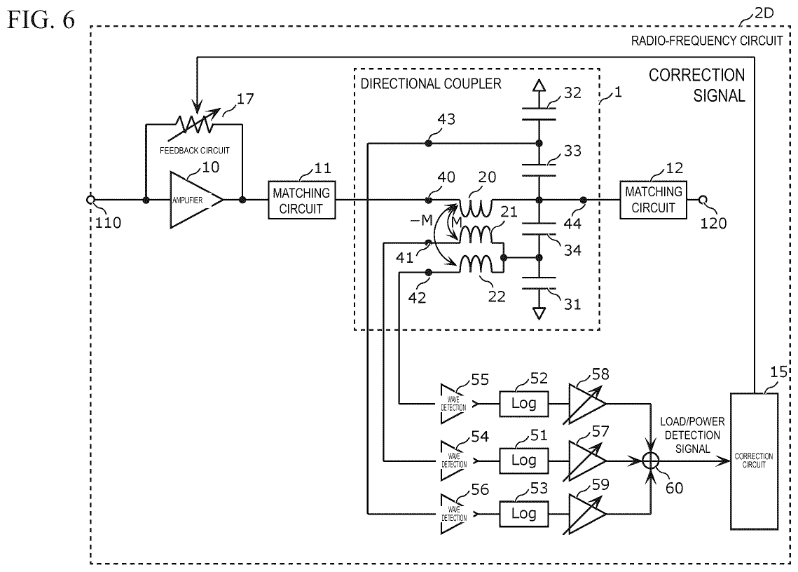

Next, a circuit configuration of a radio-frequency circuit 2D according to a fourth modification will be specifically described with reference to FIG. 6. As illustrated in FIG. 6, the radio-frequency circuit 2D includes a directional coupler 1, a power amplifier 10, matching circuits 11 and 12, a correction circuit 15, logarithmic converter circuits 51, 52, and 53, wave detector circuits 54, 55, and 56, gain converter circuits 57, 58, and 59, an adder circuit 60, a radio-frequency input terminal 110, and a radio-frequency output terminal 120. The radio-frequency circuit 2D according to the present modification differs from the radio-frequency circuit 2 according to the embodiment in that the power amplifier 10 is provided with a feedback circuit 17, and the output destination of correction signals is the feedback circuit 17. The following describes the radio-frequency circuit 2D according to the present modification with a main focus on configurational features different from the radio-frequency circuit 2 according to the embodiment, and descriptions of the same configurational features as the radio-frequency circuit 2 will not be repeated.

The power amplifier 10 is an example of a radio-frequency circuit component. The power amplifier 10 is designed to amplify radio-frequency signals input by the RFIC 3 through the radio-frequency input terminal 110. The power amplifier 10 is an example of an amplifier. The power amplifier 10 is provided in a path connecting the radio-frequency input terminal 110 and the directional coupler 1. The gain of the power amplifier 10 can be varied based on the signals output by the adder circuit 60. The power amplifier 10 is provided with the feedback circuit 17, which is coupled to an input end and an output end of the power amplifier 10. The feedback circuit 17 is designed to receive the correction signal output by the correction circuit 15.

The feedback circuit 17 includes, for example, at least one of a variable resistive element and a variable capacitive element. The feedback ratio of the feedback circuit 17 can be changed by varying the resistance of the variable resistive element and/or the capacitance of the variable capacitive element. The variable resistive element may, for example, include multiple resistive elements of different resistances, and at least one of the resistive elements may be selected using a switch. The variable capacitive element may, for example, include multiple capacitive elements of different capacitances, and at least one of the capacitive elements may be selected using a switch.

The correction circuit 15 is coupled between an output terminal of the adder circuit 60 and the feedback circuit 17. The correction circuit 15 is designed to generate a correction signal corresponding to the addition signal output by the adder circuit 60 and outputs the correction signal to the feedback circuit 17. For example, the feedback ratio of the feedback circuit 17 can be varied base on this correction signal. The output destination of the correction signal may be the matching circuit 11 or 12 as well as the feedback circuit 17.

For example, when the gain of the power amplifier 10 is varied in an increasing manner, the feedback ratio of the feedback circuit 17 is increased via the correction signal obtained through signal processing of the first radio-frequency signal to the third radio-frequency signal detected using the directional coupler 1. Increasing the feedback rate of the feedback circuit 17 decreases the gain of the power amplifier 10. Conversely, when the gain of the power amplifier 10 is varied in a decreasing manner, the feedback ratio of the feedback circuit 17 is decreased via the correction signal obtained through signal processing of the first radio-frequency signal to the third radio-frequency signal detected using the directional coupler 1. Decreasing the feedback rate of the feedback circuit 17 increases the gain of the power amplifier 10.

By contrast, with the configuration described above of the radio-frequency circuit 2D, three kinds of signals including at least two electromagnetic field coupling signals containing imaginary components can be output from the detection terminals and logarithmically converted and added together. Consequently, the power of radio-frequency signals output by the power amplifier 10 and the magnitude and phase of the load reflection coefficient can be accurately detected. As a result, the highly accurately detected power information and load impedance information (correction signal) can be fed back to the feedback circuit 17 to mitigate gain variations of the power amplifier 10.

### 2 Effects

As described above, the directional coupler 1 according to the embodiment includes the input terminal 40, the output terminal 44, the detection terminal 41, the main line 20 coupled to the input terminal 40 and the output terminal 44, the sub-line 21, and the capacitor 31. The sub-line 21 and the main line 20 are arranged in a manner that enables magnetic field coupling and electric field coupling. The sub-line 21 is coupled to one end of the capacitor 31 and the detection terminal 41. The other end of the capacitor 31 is coupled to ground.

With this configuration, the sub-line 21 and the main line 20 are arranged in a manner that enables magnetic field coupling and electric field coupling, and the capacitor 31 is incorporated. With this configuration, signals can be generated in the sub-line 21 through electromagnetic field coupling. These signals are formed by combining signal components generated through magnetic field coupling and signal components generated through electric field coupling in an out-of-phase manner. These signals generated through electromagnetic field coupling can be output from the detection terminal 41. This configuration enables the directional coupler 1 to detect signals generated through electromagnetic field coupling and use the signals to enhance the accuracy of load impedance detection.

In an example, the directional coupler 1 may further include the sub-line 22, the capacitor 32 provided in series in the first path connecting the main line 20 and ground, the capacitor 33 provided in series in the first path between the capacitor 32 and the main line 20, and the detection terminals 42 and 43. The sub-line 22 and the main line 20 may be arranged in a manner that enables magnetic field coupling and electric field coupling. The sub-line 22 may be coupled to one end of the capacitor 31 and the detection terminal 42. The detection terminal 43 may be coupled to the connection point of the capacitors 32 and 33 in the first path.

With this configuration, the sub-line 22 and the main line 20 are arranged in a manner that enables magnetic field coupling and electric field coupling, and the capacitor 31 is incorporated. With this configuration, signals can be generated in the sub-line 22 through electromagnetic field coupling. These signals are formed by combining signal components generated through magnetic field coupling and signal components generated through electric field coupling in an out-of-phase manner. As a result, three kinds of signals including at least two electromagnetic field coupling signals containing imaginary components can be output from the detection terminals 41 to 43. This configuration enhances the accuracy of load impedance detection.

The radio-frequency circuit 2 according to the embodiment may include the radio-frequency input terminal 110 and the radio-frequency output terminal 120, the directional coupler 1, the logarithmic converter circuit 51 coupled to the detection terminal 41, the logarithmic converter circuit 52 coupled to the detection terminal 42, the logarithmic converter circuit 53 coupled to the detection terminal 43, the adder circuit 60 coupled to the logarithmic converter circuits 51 to 53 and, the radio-frequency circuit component may be provided in a path connecting the radio-frequency input terminal 110 and the directional coupler 1 or a path connecting the radio-frequency output terminal 120 and the directional coupler 1 and coupled to the output terminal of the adder circuit 60.

With this configuration, the signals output from the directional coupler 1 can be logarithmically converted. As such, the power component, the load impedance resistance component, and the load impedance reactance component can be extracted with high accuracy through simple arithmetic processing. The extracted power component, load impedance resistance component, and load impedance resistance reactance component can be used to improve the characteristics of the radio-frequency circuit component. As such, this configuration enhances the accuracy of load impedance detection and improves the characteristics of the radio-frequency circuit component.

In an example, the radio-frequency circuit 2 may further include the correction circuit 15 coupled between the output terminal of the adder circuit 60 and the radio-frequency circuit component and configured to output correction signals to the radio-frequency circuit component.

With this configuration, the characteristics of the radio-frequency circuit component can be stabilized based on the extracted power component, load impedance resistance component, and load impedance resistance reactance component.

In an example, in radio-frequency circuit 2, the radio-frequency circuit component may be the power amplifier 10.

With this configuration, the gain of the power amplifier 10 can be controlled based on the extracted power component, load impedance resistance component, and load impedance reactance component. Consequently, the power of radio-frequency signals travelling through the main line 20 can be stabilized.

In an example, in the radio-frequency circuit 2, the power amplifier 10 may be provided with the feedback circuit 17 configured to receive the signals output by the correction circuit 15 and coupled to the input end and the output end of the power amplifier 10.

With this configuration, the feedback ratio for the power amplifier 10 can be controlled based on the extracted power component, load impedance resistance component, and load impedance reactance component. Consequently, the gain of the power amplifier 10 can be optimized.

In an example, in radio-frequency circuit 2, the radio-frequency circuit component may be the matching circuit 11.

With this configuration, the impedance of the matching circuit 11 can be controlled based on the extracted power component, load impedance resistance component, and load impedance reactance component. Consequently, radio-frequency signals can be transferred with low loss through the main line 20.

In an example, in radio-frequency circuit 2, the radio-frequency circuit component may be the attenuator 16.

With this configuration, the attenuation rate of the attenuator 16 can be controlled based on the extracted power component, load impedance resistance component, and load impedance reactance component. Consequently, the power of radio-frequency signals travelling through the main line 20 can be stabilized.

In an example, in the radio-frequency circuit 2, each of the logarithmic converter circuits 51 to 53 may include a diode or bipolar transistor.

With this configuration, since the voltage-current characteristic of diodes and bipolar transistors follows an exponential function, a logarithmic input-output characteristic can be achieved with a simplified configuration by using current as the input and voltage as the output.

In an example, the radio-frequency circuit 2 may further include the wave detector circuit 54 coupled between the detection terminal 41 and the logarithmic converter circuit 51, the wave detector circuit 55 coupled between the detection terminal 42 and the logarithmic converter circuit 52, the wave detector circuit 56 coupled between the detection terminal 43 and the logarithmic converter circuit 53, the gain converter circuit 57 coupled between the logarithmic converter circuit 51 and the adder circuit 60, the gain converter circuit 58 coupled between the logarithmic converter circuit 52 and the adder circuit 60, and the gain converter circuit 59 coupled between the logarithmic converter circuit 53 and the adder circuit 60.

With this configuration, the first alternating current signal to the third alternating current signal output by the directional coupler 1 can be converted to direct current signals, logarithmically converted, and gain converted. As such, the power component, the load impedance resistance component, and the load impedance reactance component can be extracted with high accuracy through simple arithmetic processing.

The directional coupler 1 according to the embodiment includes the input terminal 40, the output terminal 44, the detection terminal 41, the main line 20 coupled to the input terminal 40 and the output terminal 44, the sub-line 21, and the capacitor 31. The sub-line 21 and the main line 20 are at least partially positioned adjacent to each other. The sub-line 21 is coupled to one end of the capacitor 31 and the detection terminal 41. The other end of the capacitor 31 is coupled to ground.

The directional coupler 1 according to the embodiment includes the input terminal 40, the output terminal 44, the detection terminal 41, the main line 20 coupled to the input terminal 40 and the output terminal 44, the sub-line 21, and the capacitor 31. No interconnection is provided between the sub-line 21 and the main line 20. The sub-line 21 is coupled to one end of the capacitor 31 and the detection terminal 41. The other end of the capacitor 31 is coupled to ground.

With this configuration, the sub-line 21 and the main line 20 are at least partially positioned adjacent to each other, and the capacitor 31 is incorporated. With this configuration, signals can be generated in the sub-line 21 through electromagnetic field coupling. These signals are formed by combining signal components generated through magnetic field coupling and signal components generated through electric field coupling in an out-of-phase manner. These signals generated through electromagnetic field coupling can be output from the detection terminal 41. This configuration enables the directional coupler 1 to detect signals generated through electromagnetic field coupling and use the signals to enhance the accuracy of load impedance detection.

In an example, the directional coupler 1 may further include the sub-line 22, the capacitor 32 provided in series in the first path connecting the main line 20 and ground, the capacitor 33 provided in series in the first path between the capacitor 32 and the main line 20, and the detection terminals 42 and 43. The sub-line 22 and the main line 20 may be at least partially positioned adjacent to each other. The sub-line 22 may be coupled to one end of the capacitor 31 and the detection terminal 42. The detection terminal 43 may be coupled to the connection point of the capacitors 32 and 33 in the first path.

With this configuration, the sub-line 22 and the main line 20 are at least partially positioned adjacent to each other, and the capacitor 31 is incorporated. With this configuration, signals can be generated in the sub-line 22 through electromagnetic field coupling. These signals are formed by combining signal components generated through magnetic field coupling and signal components generated through electric field coupling in an out-of-phase manner. As a result, three kinds of signals including at least two electromagnetic field coupling signals containing imaginary components can be output from the detection terminals 41 to 43. This configuration enhances the accuracy of load impedance detection.

The communication device 5 according to the embodiment includes the RFIC 3 configured to process radio-frequency signals and the radio-frequency circuit 2 configured to transfer radio-frequency signals between the RFIC 3 and the antenna 4.

This configuration enables the communication device 5 to achieve the same effects as the radio-frequency circuit 2.

### Other Embodiments

The directional couplers, radio-frequency circuits, and communication device according to the present disclosure have been described by using the embodiment and modifications, but the present disclosure is not limited to the embodiment and modifications. The present disclosure also embraces other modifications obtained by making various alterations to the embodiment and modifications that occur to those skilled in the art without necessarily departing from the scope of the embodiment, and various hardware devices incorporating the directional couplers, radio-frequency circuits, and communication device according to the present disclosure.

For example, in the directional couplers, radio-frequency circuits, and communication device according to the embodiment and modifications, matching elements such as inductors or capacitors, and switching circuits may be coupled among the constituent elements. The inductors may include interconnect inductors formed by wires that connect the constituent elements.

### INDUSTRIAL APPLICABILITY

The present disclosure can be used as directional couplers in a wide variety of applications.

### REFERENCE SIGNS LIST

1 directional coupler
2, 2A, 2B, 2C, 2D radio-frequency circuit
3 RFIC
4 antenna
5 communication device
10, 13 power amplifier
11, 12, 14 matching circuit
15 correction circuit
16 attenuator
17 feedback circuit
20 main line
21, 22 sub-line
31, 32, 33, 34 capacitor
40 input terminal
41, 42, 43 detection terminal
44 output terminal
51, 52, 53 logarithmic converter circuit
54, 55, 56 wave detector circuit
57, 58, 59 gain converter circuit
60 adder circuit
61 switch
90 substrate
90a, 90b major surface
110, 111 radio-frequency input terminal
120 radio-frequency output terminal

1. A directional coupler comprising:
an input terminal;
an output terminal;
a first detection terminal;
a main line coupled to the input terminal and to the output terminal;
a first sub-line; and
a first capacitive circuit element,
wherein the first sub-line and the main line are arranged in a manner that enables magnetic field coupling and electric field coupling therebetween,
wherein the first sub-line is coupled to a first end of the first capacitive circuit element and to the first detection terminal, and
wherein a second end of the first capacitive circuit element is coupled to ground.

2. The directional coupler according to claim 1, further comprising:
a second sub-line;
a second capacitive circuit element in series in a first path connecting the main line and ground;
a third capacitive circuit element in series in the first path, between the second capacitive circuit element and the main line;
a second detection terminal; and
a third detection terminal,
wherein the second sub-line and the main line are arranged in a manner that enables magnetic field coupling and electric field coupling therebetween,
wherein the second sub-line is coupled to a first end of the first capacitive circuit element and to the second detection terminal, and
wherein the third detection terminal is coupled to a connection point of the second capacitive circuit element and the third capacitive circuit element in the first path.

3. A radio-frequency circuit comprising:
a radio-frequency input terminal and a radio-frequency output terminal;
the directional coupler according to claim 2;
a first arithmetic circuit coupled to the first detection terminal;
a second arithmetic circuit coupled to the second detection terminal;
a third arithmetic circuit coupled to the third detection terminal;
an adder circuit coupled to the first arithmetic circuit, the second arithmetic circuit, and the third arithmetic circuit; and
a radio-frequency circuit component in a path connecting the radio-frequency input terminal and the directional coupler or in a path connecting the radio-frequency output terminal and the directional coupler, the radio-frequency circuit component being coupled to an output terminal of the adder circuit.

4. The radio-frequency circuit according to claim 3, further comprising:
a correction circuit coupled between the output terminal of the adder circuit and the radio-frequency circuit component, the correction circuit being configured to output a correction signal to the radio-frequency circuit component.

5. The radio-frequency circuit according to claim 4, wherein the radio-frequency circuit component is an amplifier.

6. The radio-frequency circuit according to claim 5, wherein the amplifier is in a feedback circuit configured to receive a signal output by the correction circuit, the feedback circuit being coupled to an input end and an output end of the amplifier.

7. The radio-frequency circuit according to claim 4, wherein the radio-frequency circuit component is a matching circuit.

8. The radio-frequency circuit according to claim 4, wherein the radio-frequency circuit component is an attenuator.

9. The radio-frequency circuit according to claim 3, wherein each of the first arithmetic circuit, the second arithmetic circuit, and the third arithmetic circuit comprises a diode or bipolar transistor.

10. The radio-frequency circuit according to claim 3, wherein each of the first arithmetic circuit, the second arithmetic circuit, and the third arithmetic circuit is a logarithmic converter circuit.

11. The radio-frequency circuit according to claim 3, further comprising:
a first wave detector circuit coupled between the first detection terminal and the first arithmetic circuit;
a second wave detector circuit coupled between the second detection terminal and the second arithmetic circuit;
a third wave detector circuit coupled between the third detection terminal and the third arithmetic circuit;
a first gain converter circuit coupled between the first arithmetic circuit and the adder circuit;
a second gain converter circuit coupled between the second arithmetic circuit and the adder circuit; and
a third gain converter circuit coupled between the third arithmetic circuit and the adder circuit.

12. A directional coupler comprising:
an input terminal;
an output terminal;
a first detection terminal;
a main line coupled to the input terminal and to the output terminal;
a first sub-line; and
a first capacitive circuit element,
wherein the first sub-line and the main line are at least partially adjacent to each other,
wherein the first sub-line is coupled to a first end of the first capacitive circuit element and to the first detection terminal, and
wherein a second end of the first capacitive circuit element is coupled to ground.

13. A directional coupler comprising:
an input terminal;
an output terminal;
a first detection terminal;
a main line coupled to the input terminal and to the output terminal;
a first sub-line; and
a first capacitive circuit element,
wherein there is no interconnection between the first sub-line and the main line,
wherein the first sub-line is coupled to a first end of the first capacitive circuit element and to the first detection terminal, and
wherein a second end of the first capacitive circuit element is coupled to ground.

14. The directional coupler according to claim 12, further comprising:
a second sub-line;
a second capacitive circuit element in series in a first path connecting the main line and ground;
a third capacitive circuit element in series in the first path, between the second capacitive circuit element and the main line;
a second detection terminal; and
a third detection terminal,
wherein the second sub-line and the main line are at least partially adjacent to each other,
wherein the second sub-line is coupled to a first end of the first capacitive circuit element and to the second detection terminal, and
wherein the third detection terminal is coupled to a connection point of the second capacitive circuit element and the third capacitive circuit element in the first path.

15. The directional coupler according to claim 13, further comprising:
a second sub-line;
a second capacitive circuit element in series in a first path connecting the main line and ground;
a third capacitive circuit element in series in the first path, between the second capacitive circuit element and the main line;
a second detection terminal; and
a third detection terminal,
wherein the second sub-line and the main line are at least partially adjacent to each other,
wherein the second sub-line is coupled to a first end of the first capacitive circuit element and to the second detection terminal, and
wherein the third detection terminal is coupled to a connection point of the second capacitive circuit element and the third capacitive circuit element in the first path.

16. A radio-frequency circuit comprising:
a radio-frequency input terminal and a radio-frequency output terminal;
the directional coupler according to claim 14;
a first arithmetic circuit coupled to the first detection terminal;
a second arithmetic circuit coupled to the second detection terminal;
a third arithmetic circuit coupled to the third detection terminal;
an adder circuit coupled to the first arithmetic circuit, the second arithmetic circuit, and the third arithmetic circuit; and
a radio-frequency circuit component in a path connecting the radio-frequency input terminal and the directional coupler or in a path connecting the radio-frequency output terminal and the directional coupler, the radio-frequency circuit component being coupled to an output terminal of the adder circuit.

17. A radio-frequency circuit comprising:
a radio-frequency input terminal and a radio-frequency output terminal;
the directional coupler according to claim 15;
a first arithmetic circuit coupled to the first detection terminal;
a second arithmetic circuit coupled to the second detection terminal;
a third arithmetic circuit coupled to the third detection terminal;
an adder circuit coupled to the first arithmetic circuit, the second arithmetic circuit, and the third arithmetic circuit; and
a radio-frequency circuit component in a path connecting the radio-frequency input terminal and the directional coupler or in a path connecting the radio-frequency output terminal and the directional coupler, the radio-frequency circuit component being coupled to an output terminal of the adder circuit.

18. The radio-frequency circuit according to claim 16, further comprising:
a correction circuit coupled between the output terminal of the adder circuit and the radio-frequency circuit component, the correction circuit being configured to output a correction signal to the radio-frequency circuit component.

19. The radio-frequency circuit according to claim 17, further comprising:
a correction circuit coupled between the output terminal of the adder circuit and the radio-frequency circuit component, the correction circuit being configured to output a correction signal to the radio-frequency circuit component.

20. A communication device comprising:
a signal processing circuit configured to process a radio-frequency signal received or to be transmitted by an antenna; and
the radio-frequency circuit according to claim 3, the radio-frequency circuit being configured to transfer the radio-frequency signal between the antenna and the signal processing circuit.
